(19) United States
(12) Patent Application Publication
(10) Pub. No.: US 2016/0180390 A1
(43) Pub. Date: Jun. 23, 2016

(54) Advertisement-Based Internet Service Method and Controller for Implementing the Same

(71) Applicant: Andre Schussel, Sao Paulo (BR)

(72) Inventor: Andre Schussel, Sao Paulo (BR)

(21) Appl. No.: 15/055,594

(22) Filed: Feb. 28, 2016

Related U.S. Application Data
(63) Continuation-in-part of application No. 14/017,002, filed on Sep. 3, 2013.
(60) Provisional application No. 61/696,979, filed on Sep. 5, 2012.

(51) Int. Cl. G06Q 30/02

(52) U.S. Cl. CPC G06Q 30/0257

(57) ABSTRACT

A method and controller for internet access involves connecting a user device to the internet as a result of an advertisement displayed on the user device and displaying it on the user device, displaying a digital indicator on the user device to indicate the status of the user's connection to the internet based on the at least one advertisement displayed; and changing the digital indicator displayed on the user device during the period of the user's connection to the internet to reflect the user's connection thereto.

### CROSS REFERENCE TO RELATED APPLICATIONS

This application is a continuation-in-part of U.S. patent application Ser. No. 14/017,002, filed on Sep. 3, 2013, which claims the benefit of priority of U.S. Provisional Patent Application Ser. No. 61/696,979, filed on Sep. 5, 2012, the disclosures of each of the foregoing applications being incorporated by reference in their entirety into the disclosure of this application.

### TECHNICAL FIELD OF THE INVENTION

The present invention relates to mobile advertising software, applications, systems, and methods of controlling access to internet services on PC systems, mobile phones, and tablets.

### BACKGROUND

Conventional internet service providers require users to pay a fee for access to wired or wireless internet.

Users who do not have data access, cannot afford data access, or wish to use a different type of data access than currently used are limited in their options to engage in internet usage outside of conventional internet services such as, for example, paying a fee for a different internet service provider.

For internet users who are mobile, roaming charges may deter alternative data plan purchases and prepaid data plans may be insufficient to allow a user to access an alternative plan while roaming.

Desktops and portables computers running any operating system (OS) like Windows, MacOS, or Linux and mobile devices (cellular phones and tablets) running any OS like iOS, Android, or Windows Phone are defined as user terminals. End users are defined as any people using its terminal.

Application is the term used to define the software invention that provides the mechanism of controlling the IP communication.

Authorization code is a code provided by the service provider and is required to prevent fraud and network control. This code is obtained via short message service (SMS) registration or portal registration.

A mobile IP channel is a mobile operator service such as, for example, GSM, WCDMA, 2G, 3G and 4G Radio Frequency data transmission sources.

The term PDP shall mean Packet Data Protocol.

The term PDN shall mean Packet Data Network.

The term MSISDN shall mean a Mobile Subscriber Integrated Services Digital Network Number.

The term IMSI shall mean an International Mobile Subscriber Identity.

The term SSID shall mean a Service Set Identifier, such as, for example, the name of a WiFi network.

A SIM card may be a subscriber identity module or subscriber identification module (SIM) is an integrated circuit that securely stores the International Mobile Subscriber Identity (IMSI).

The term HLR shall mean Home Location Register.

The term HSS shall mean Home Subscriber Server.

LTE has been designed to support packet services in a more efficient manor than 3G. The key service, from a wireless data network perspective, is the establishment of the data session that will be used by the mobile device for data services. In 2G/2.5G and 3G, the key to establishing a data session is the Packet Data Protocol (PDP) Context establishment procedure. In LTE, the procedure has been changed to an Evolved Packet System (EPS) Bearer Setup.

When a Primary PDP Context is established, this allocates an IP address to the mobile device. Like described before, the application will manage the PDP context for its own purposes and use of special parameters values.

If the solution is operating under an LTE network, instead of managing the PDP context it may manage the Default EPS Bearer and Dedicated EPS Bearer under the packet date network connection (PDN Connection).

### SUMMARY OF THE INVENTION

Systems and software for personal computers (PC), such as desktops and portable computers, and mobile devices (MD), such as cellular phones and tablets, may focus on controlling IP communication channels that will provide end user IP data access for free or sponsored in exchange for advertisements, solicitations, or other third party access to the mobile device or personal computer.

An exemplary method and system includes a client-software for PCs and MDs, an advertisement server (AdS), which may send one or more new advertisements to the user, and a Fraud Prevention Server (FPS). Additionally, an exemplary method and system may require a registration portal depending on each service provider (SP).

An exemplary AdS advertisement may be similar to a television commercial or cinema intermission in that the terminal IP communications are temporarily stopped, one or more advertisements or other third party content are communicated to the terminal or web browser screen, and allow user(s) to resume data activity upon conclusion of the advertisement or third party content.

In one example, an AdS advertisement may be in the form of a banner, a full-screen image or video covering a web-page or terminal screen, or a partially covered web-page or terminal screen of the user. According to one aspect of an exemplary system and method, an advertiser may select the characteristics of the AdS advertisement. In another example, the AdS advertisement may allow a user to opt into a newsletter or loyalty program with such advertiser.

In another example, the AdS advertisement can be interactive with the user to allow for additional system functionalities. In one aspect, the AdS advertisement may request the user's email(s) and/or GPS locations. In another aspect, the AdS advertisement may allow the user to exchange miles or loyalty programs points as coupons to get system-use credits (SUCs), e.g., more internet connection time, data usage, on the system. In another aspect, the AdS may operate as a message board or a questionnaire. In another aspect, the AdS advertisement may offer coupons based on consumer engagement, via a sale offer, or be sponsored by the advertiser. In yet another aspect certain eligible users may be offered to convert SUCs into traditional wireless telecom services credits, e.g., pre-paid minutes for mobile phones, SMS credits for mobile phones, call time on Skype. According to the aforementioned aspect, users may be allowed to engage features via the AdS advertisement that automatically posts on the user's social media account, e.g., Facebook, Twitter, that serves as a further advertisement of the sponsor/advertiser in exchange for SUCs. In still another aspect, a user can be given SUCs by identifying others who would like to use the system to establish internet connections. In this aspect, the system may prompt the user to identify other potential users or may ask new users to identify referring individuals prior to use of the system.

### BRIEF DESCRIPTION OF THE DRAWINGS

FIG. 1 shows a diagrammatic view of an ad-based internet system.

FIG. 2 shows an exemplary mobile terminal main screen.

FIG. 3 shows an exemplary service provider selection screen.

FIG. 4 shows an exemplary registration portal screen.

FIG. 5 shows an exemplary AdS administrative graphical user interface.

FIG. 6 shows another exemplary AdS administrative graphical user interface.

FIG. 7 shows an exemplary user-control administrative graphical user interface.

FIG. 8 shows another exemplary user-control administrative graphical user interface.

FIG. 9 shows an exemplary application browser screen.

FIG. 10 shows an exemplary user-preference selection portal.

FIG. 11 shows an exemplary method of services.

FIGS. 12A-12E show an exemplary timer controller for an exemplary application browser screen.

FIG. 13 shows an exemplary status screen for a graphical user interface.

In the drawings like characters of reference indicate corresponding parts in the different figures.

### DETAILED DESCRIPTION

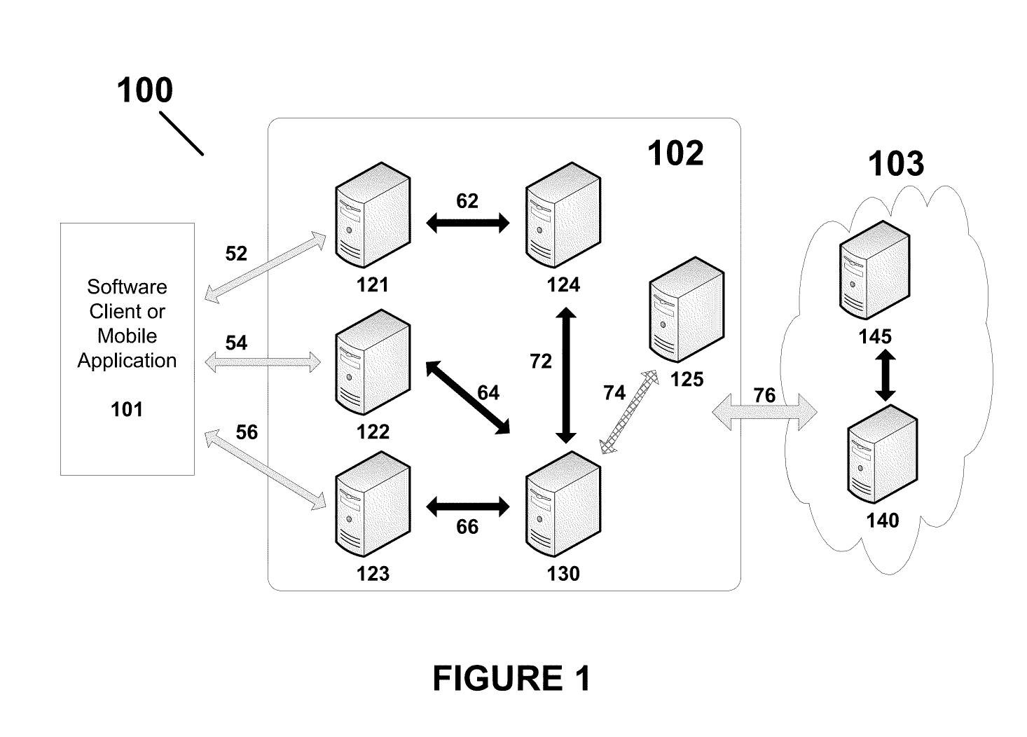

With reference to FIG. 1, an exemplary general architecture of an ad-based internet service system 100 may include a client device 101, a service provider network 102, and an internet cloud 103. An exemplary client device 101 may be embodied by a cellular telephone, lap top, smart phone (such as, for example, Android or iPhone), tablet PC, or desktop computer. The client device 101 may contain one or more processors and attendant circuitry known to those in the art which enable the device 101 to execute software to run one or more applications consistent with the teachings and description provided herein. For example, a smart phone may contain a processor configured to run a mobile application that works in conjunction with an internet service provider to provide data communication between one or more websites and the user's phone.

An exemplary service provider network 102 may include one or more Serving GPRS Support Nodes (SGSN) 121 such as, for example, Cisco SGSN Serving GPRS Support Nodes sold by Cisco Systems, Inc. of San Jose, Calif. Other SGSN or SGW of Alcalu and Ericsson are also suitable alternatives. An SGSN 121 may provide internet communication via 2G, 2.5G or 3G communication channels 52 to one or more 2G, 2.5G, and/or 3G compatible client devices 101. The service provider network 102 may alternatively include one or more signaling gateways (S-GW), such as, for example an SGW Serving Gateway sold by Cisco Systems, Inc. of San Jose, Calif. An SGW 122 may provide internet communication via LTE or 4G communication channels 54 to one or more LTE or 4G compatible client devices 101. In another exemplary network 102, a WiFi portal. Similar to an SGW 122, a WiFi portal 123 may provide internet communication via LTE or 4G communication channels 56 to one or more LTE or 4G compatible client devices 101. These various servers 121, 122, and 123 may communicate with one or more user devices 101 via one or more of the possible communication channels 52, 54, or 56 depending on the user's device compatibility, terms of service, and service provided by the system 100 to the user.

Depending on the hardware used to communicate with a user device 101, one or more of the servers 121, 122, and 123 may coordinate data transfer between the user and the network in certain ways. For example, for an exemplary SGSN 121, a direct communication channel 62, such as an Ethernet or wireless connection, is provided between the SGSN 121 and a Gateway GPRS Support Node (GGSN) 124. An exemplary GGSN 124 may include the Cisco Gateway GPRS Support Node sold by Cisco Systems, Inc. of San Jose, Calif. Ultimately, an exemplary SGSN 121 may communicate via channel 72 to a user-control server 130. In another exemplary embodiment, an S-GW 122 or WiFi portal 123 may communicate with the user-control server 130 by channels 64 and 66 respectively.

According to an exemplary embodiment of the present invention, user-control server (UCS) 130 may act as a proxy server within the service provider network 102. According to an exemplary embodiment, a UCS 130 may monitor the behavior of the user device 101 and control content provision to the user device 101 from internet gateway 125. The channel of communication 74 between gateway 125 and UCS 130 may be hardwire or wireless, but preferably a landline connection with sufficient service bandwidth and data delivery capabilities. Usually, the internet gateway belongs to one or more service providers.

In a preferred embodiment, UCS 130 may be a fraud prevention server (FPS). The FPS Server 130 may act as a session control for each user device 101 using internet services from service provider network 102. In an exemplary service method, once a user device 101 sends communications via one or more servers 121-124 and channels 52, 54, 56, 62, 64, 66 and 72 to FPS 130, the FPS may redirect the user device 101 so as to allow internet connectivity between gateway 125 and user device 101. As described in this exemplary method, FPS 130 may serve as security of service network 102 as well as maintain integrity of internet connections from gateway 125 throughout the user device 101 use of the system 100.

As far as inspection of IP packets for knowing user MSISDN, UCS/FPS Server 130 may also look for user device information like OS type and language, web browser/device/connection type and other possible info available to request the most suitable advertisement for the user. Moreover, UCS/FPS Server 130 may keep a record locally of how many connections per day or how many connections per MSISDN.

According to one aspect of an exemplary advertisement-based service method and system, a user device 101 may require an operator SIM card registration and network signal if SIM card is available. Upon registration, a user device 101 may be configured to launch an application to connect a user device 101 to gateway 125 via a network having a UCS 130 and AdS 140/145. A user may be given the option to select a type of network connection, such as GSM or DMA mobile IP channels from a mobile operator or WiFi from a mobile operator or hotspot WiFi provider.

In one embodiment, an unrecognized user device 101 may need to register with the ad-based internet service system. In one embodiment, an exemplary registration may involve the system's delivery of an SMS or text message to a mobile user device 101. Alternatively, an exemplary registration process may involve redirecting the browsing screen of a user device 101 to a registration portal. In either of the aforementioned exemplary scenarios, the user device 101 may receive an authorization code via SMS or portal screen. In a preferred embodiment in which a WiFi connection is used, a redirected portal would be most likely to be means for registration of a user device 101. In another preferred embodiment, a user authorization code together with device 101 mobile phone number (MSISDN) are stored at service provider HLR/HSS and checked in order to guarantee security aspects. In a preferred embodiment, one authorization code should be generated for each mobile phone number (MSISDN) a user has.

In an exemplary embodiment in which users have an active SIM Card, users with active SIM Card may already be authenticated by mobile operators using SIM card network standard authentication. In an exemplary embodiment of the described system and method, the system may maintain 3GPP and LTE security aspects, such as IP spoofing prevention using the SIM card standard authentication. With the service authorization code generated when registration is done, it provides extra security to avoid fraud, as a mobile operator network could prior to enable data channel checks (normally at HLR/VLR database) if the code matches the one previously generated to the user (identified by IMSI/MSISDN) when SMS requesting service was sent or code generated at a web portal.

In yet another exemplary embodiment, a WiFi portal authentication may be located at some point within the service provider network 102 or, alternatively, may be hidden/embedded in the user device browser or software. A “hidden” portal may be used to block users who attempt to reach the WiFi portal without the application, resulting in a blocked message being sent to the user device screen or display of an empty page.

This portal serves as the login input from application to service provider generate/control the user IP default gateway access/IP addresses and apply any QoS needed. Additionally an exemplary system and method may set a “keep-alive” control between an exemplary portal and mobile terminal as another source of security and quality of service control. According to this exemplary embodiment of the system and method described, such a portal may serve as an authentication portal which may control connections to one or more users whose IP address(es) have been authenticated.

In another exemplary embodiment of the system and method described, a user may fill out an information request screen. In one aspect of the exemplary method, the information provided by the user may be used by service providers to target specific advertisements at the user during a session when the user is logged into the service provider network 102. For example, when enrolling, a user can respond to a ‘likes and dislikes’ menu to more correctly and/or more efficiently target advertisements.

Alternatively, information gathered from users may provide future sessions with the service provider network 102 to properly authenticate and register the user on a particular user device 101. For advertisement providers, report and control features may be beneficial for targeted advertisements as well as particular internet service sponsorship. In an exemplary embodiment, an AdS 140 may have a username and password for each advertiser/sponsor and will record relevant usage info, only authorized information from one or more user(s), and will manage a database.

An exemplary FPS Server may be a redundant server and will be able to handle a huge amount of data and will talk to GGSN/S-GW using radius, diameter or any other protocol if needed. It may be the case that the FPS Server should do a look-up at HSS server database in order to retrieve end user MSISDN data. Each participating service provider may have an FPS Server 130 in the sponsored internet services deployment. In one or more exemplary systems and methods, an FPS 130 may be optional without detriment to the control and operation of the system or method.

Coupled to the service provider network 102 may be an advertisement service cloud 103 including one or more AdS 140 and connected advertisement databases 145. An exemplary AdS 140 may be any commercially available server configured for multiple user applications and can accommodate an “n” client-server mode. An exemplary AdS 140 may control and register all advertisements demanded from “n” clients applications (stored on one or more user device 101), and send to these application clients advertisements from an internal advertisement database/external database 145. An exemplary external advertisement database 145 may include, for example, Grey strips, Mojiva, Google, or Facebook.

In an exemplary operation of the system and method, a PC or MD 101 may be provided IP data access for free or sponsored in exchange of receiving advertisements from one or more AdS 140 and AdS databases 145. To control the advertisements communicated to the user device 101, a client software for PCs and MDs may work with user-control terminal 130 and one or more AdS 140 to send advertisements to the view screen of the mobile device 101.

In the exemplary operation of the system and method described herein, advertisements may be communicated to user device 101 and in doing so, may temporarily stop terminal IP communications between user device 101 and gateway 125. At that time, an exemplary advertisement may occupy one or more portions of the user terminal 101 or user's web browser screen. Advertisements may be stored on AdS database 145. After a predetermined time of interaction with the advertisement, the user device 101 may resume communications with gateway 125. An exemplary advertisement may be one of a pop-up, a banner, a flash video, a transparent frame, an audio message, a download, or a combination of activities depending on what the advertiser wants. In a preferred embodiment, when an application determines after “x” seconds/minutes that it is time to send an advertisement to the user device 101, the screen of the user device 101 may display the advertisement according to advertisement display instructions stored on one or more of the UCS/FPS 130 and/or AdS 140/145. An exemplary interval between advertisements to be displayed depends on the service provider, internet connection type, speed, user information, user search desires, data usage history, time of access to the particular network, or queue of users seeking to access the network via the desired connection.

In another alternative embodiment of an exemplary system and method, a user device 101 may store one or more advertisements or control data (such as cookies or temporary internet files) that may be read by UCS 130 or AdS 140 as requiring viewing before a session of internet provision begins. Alternatively, such control data may act as session control of the user's session. For example, if a user departs from a session prior to receiving a scheduled advertisement, control data, such as a cookie, may be stored on the user's device detailing that on the next session an advertisement is due to be shown to the user. In another variant of this example, the cookie may signal the provision of an advertisement belonging to the sponsor or service provider of the previous session. However, it may be possible that the cookie signal the provision of an advertisement of the present service provider or sponsor first and remain stored in case the user tries to subsequently re-access the internet using a service sponsored or provided by the previous sponsor or internet service provider.

In yet another variant of the above example, an advertisement may be schedule to appear at the beginning of every users' session regardless of which internet provider or sponsored internet they choose to use through the exemplary system and method. As previously described, control data or session control of the type that guides provision of advertisements to a user device 101 may be governed by UCS/FPS 130.

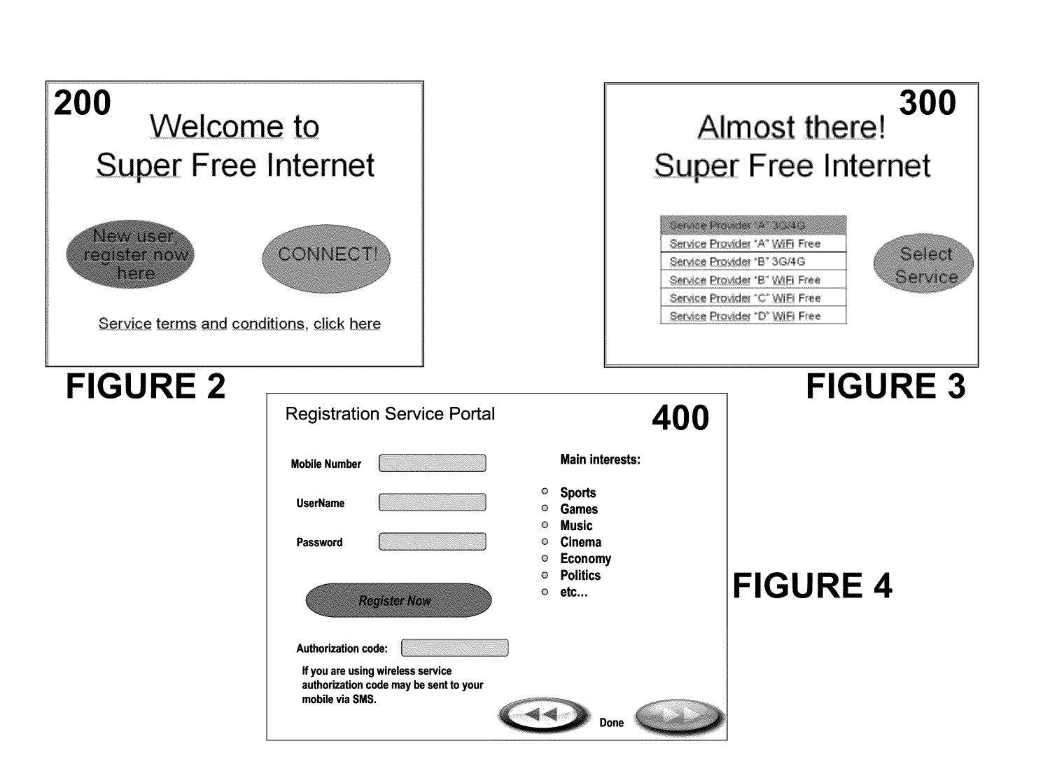

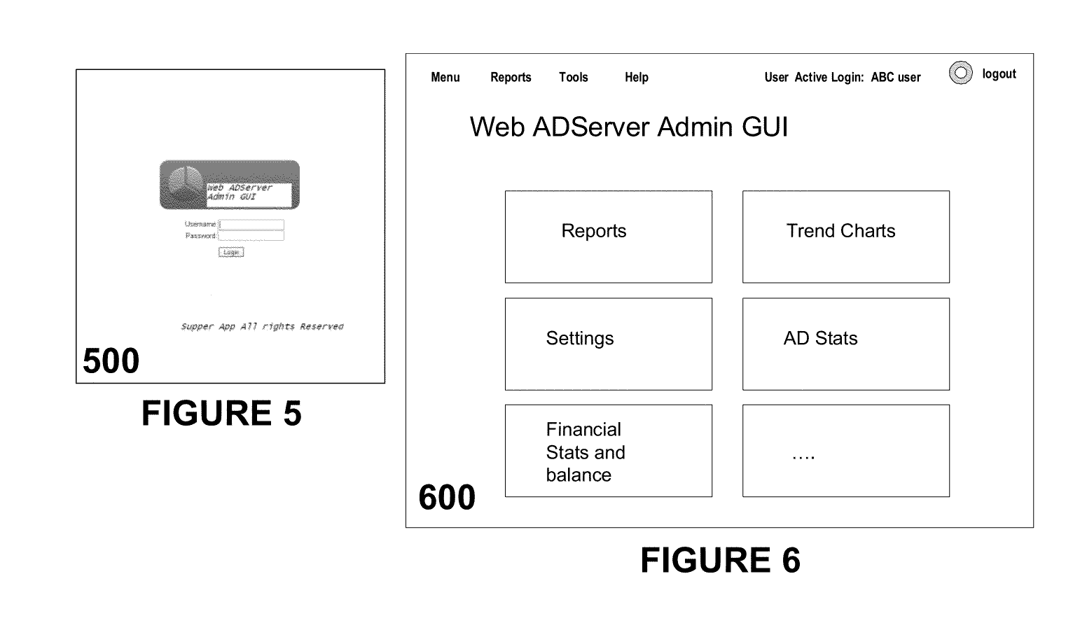

Keeping in mind an exemplary system architecture of FIG. 1, reference to FIG. 2 further details a method of use of the aforementioned exemplary system. Main screen 200 may show on user device 101 to allow users to proceed to get access to service provider network 102. In the exemplary illustration of a main screen 200, a user may register their mobile device 101 or themselves personally. Alternatively, a user may connect to the network 102. In either example, a user may be asked to agree to certain system use conditions.

FIG. 3 illustrates an exemplary channel selection screen 300. According to an exemplary embodiment of the system and method described, a user device 101 may establish one or more connections to network 102, such as, for example, connections 52, 54, and/or 56, after a user selects the type of mobile IP channel. While only exemplary, a user's channel selection screen may be determined based on the status of the user's device 101, the user's registration information, the type of potential advertising available to target the user, the sponsor of the user's internet access, or similar combinations.

In an exemplary embodiment, mobile terminals prior to connection to the internet may need to receive an IP address, such as via a PDP protocol. When the application is about to connect a user to the internet 125 it may detect if a PDP context is already established or not and if a PDP context is inactive or active. Once a current status of the terminal PDP context is detected, the application may do one or more of the following: (i) if a PDP context is established and active—the application will cancel current PDP context, and initiate a new one or just update the PDP currently used; (ii) if a PDP context is not established—the application will initiate a new PDP context; and/or (iii) if a PDP context is inactive—the application will cancel current PDP context, and initiate a new one or just re-activate and update the currently inactive PDP. While PDP context is described, alternative connections may also be established as well. For example, when connecting under an LTE/4G scenario, the exemplary system and method may manage the Default EPS Bearer and eventually Dedicated EPS Bearer (if a specific QoS information must be sent).

A PDP context managed by an exemplary system and method described may have standard parameters such as IMSI, MSISDN and may possess unique parameters such as user name, Quota=0, authorization code, and any other additional context agreed with each service provider. In a preferred embodiment, these parameter values may be sent embedded in another PDP context standard parameter previously agreed with the service provider.

In yet another preferred embodiment, embedded parameters may be sent to the SGSN/GGSN (3G and previous networks) and S-GW (LTE/4G) so the service provider network may control during the period that the PDP context is active. During an exemplary use of the system and method, parameter quota=0 may be communicated from the user device 101 and thereby indicate that no data traffic will be charged to the user.

Turning to FIG. 4, an exemplary registration service portal 400 may be shown on the screen of a user device 101. A service portal 400 may vary from service provider to service provider. At the point in the method where a user device 101 may be registered several exemplary scenarios may take place. First, a user may have an active SIM Card (with or without data plan active) or may already be connected to a different WiFi service so the application will redirect user to a registration Service Provider portal 400. Where a user may not have a data plan, the service provider will by default redirect to an exemplary registration portal 400. Second, where a user may have no active SIM Card but is already connected to a different WiFi service, an exemplary ad-based service application may redirect a user to a registration Service Provider portal 400. Third, a user may have no active SIM Card and may not be connected to any WiFi service. In this exemplary scenario, a user may agree with the service provider to permit limited access only to the registration portal 400. When a service provider does not allow such a connection, a user may have to connect to the registration portal using a PC or any terminal with internet access.

An exemplary registration portal 400 may be very simple. Preferably, a registration portal may ask basic info like mobile number, username/password, name and any other relevant information. In one preferred aspect, some info should be mandatory to be filled, like mobile number and, in situations where a user has an active SIM card, a mobile number must match. Accordingly, a successful registration may allow a portal to display the authorization code for user device 101 access to service provider network 102 In an exemplary embodiment, a mobile service provider may offer user-registration via SMS, voicemail or other ways to render an exemplary registration page 400 as a non-interactive page. In an exemplary registration step, a service provider may opt to offer user registration via SMS, in which the user may send an SMS to a specific code and then receive a SMS response with an authorization code.

According to another aspect of an exemplary system and method, a WiFi service may be offered (defined with a fixed SSID name at Service Provider level) free of charge, but may always generate a CDR from a service provider aspect to control the timing, direction, target, and amount of data transmitted.

In this exemplary embodiment, WiFi usage mode may not necessarily need to have a SIM card, but only a WiFi feature enabled at the terminal. In a preferred embodiment, a WiFi usage mode may only be operation if there had been a previous service registration. In another preferred embodiment, a WiFi usage mode may involve prior application launch and performance of standard SIM card network authentications such as EAP. In an exemplary aspect of the inventive system and method, EAP may be one particular way for service providers to avoid network fraud and attacks.

According to the exemplary system and method described, a UCS 130, such as, for example, an FPS Server, may act as a session control for each user using free internet at the service provider network and will redirect the free internet users to FPS Server. When application reconvenes a data connection with the service provider, with attendant advertisement requests from AdS 140/145, an exemplary FPS Server 130 may monitor if end user using the internet service is not trying circumvent system advertisement protocols.

In another aspect, any change by an end user to avoid advertisements while obtaining service benefits will be met with various controls of an exemplary UCS/FPS 130. For example, as FPS Server 130 controls the session and will expect an advertisement request at some point in time. After a certain amount of time elapses, such as for example, an amount of time in which an ad should be sent to a user based on the type of data connection selected and provided, the server 130 will immediately request advertisements from AdS 140/145. When the time for displaying an advertisement approaches, an Ad may be sent to the user device 101 as a full web browser screen. After some predetermined time period, the user device 101 may resume web browsing for the user. A server 130 may request whether an advertisement has taken place as scheduled based on data stored on the user device (such as control data described above), or by a signal from the AdS 140/145. In an exemplary embodiment, the failure to receive a return signal marking the completion of an advertisement may alert FPS 130 that a user may try to bypass the advertisement protocols.

Alternatively, when a new session may be redirected to the UCS/FPS 130 Server, it means end users may not be using the application as it should, or is using WiFi directly through a WiFi portal or has a mobile device that cannot download Apps but have 2G, 3G connections. Where appropriate, these user connections may be redirected to UCS/FPS Server 130 via Service Provider Network 102.

According to the above exemplary situations involving an FPS/UCS 130 server, in response to irregular use of Mobile App/PC client, an exemplary UCS/FPS 130 may commandeer the end user's session. In this way, UCS/FPS 130 may control the end user application in regard to the Web AdS 140/145 perspective and request and deliver advertisements. In this exemplary scenario the only way to display Ads to the end user is using the web browser window. An exemplary FPS Server 130 may restrict all data traffic to web browsing, such as, for example, browsing of only URL (UDP/TCP port 80).

In embodiments where a user connects using the application or tries to reproduce the exact behavior of the PC/mobile application to get rid of Ads during the session, the session connection flow starts from user device 101 and hits the GGSN/S-GW 121/122 or the WiFi portal 123. In all cases if the FPS Server 130 is present in the Service Provider 102 architecture, the GGSN/S-GW/WiFi portal will redirect traffic to FPS Server 130.

The FPS server 130 may be able to detect when a new connection was establish and if the user application is being used; detect when a connection is undergoing and under what conditions (user application activated/inactived). In an exemplary scenario where user application is inactive, an exemplary FPS Server 130 may restrict all data traffic to web browsing, such as, for example, only browse URL (UDP/TCP port 80). Based on the service provider connection type used, an exemplary UCS 130 may also determine the interval advertisements should be displayed on the user device 101.

Additionally, when a new session may be detected, and a user application is inactive, FPS Server 130 may retrieve IP packets from a user's device 101, the user's IP protocol, and lookup in a database, such as an HSS database, to retrieve at least user MSISDN, being able to forward it to AdS 140 to get new advertisements from ad database 145 to fulfill database report.

In the exemplary embodiments where the system and method allow for inspection of IP packets to determine a user's MSISDN, FPS Server 130 may also look for user device 101 information like OS type and language, web browser/device/connection type and other possible info available to request the most suitable advertisement for this current user.

An exemplary FPS Server 130 may keep a record locally, such as may be the case in exemplary methods and systems where UCS/FPS 130 operates as a redundancy of AdS 140 and advertisement database 145. In this exemplary embodiment, a UCS/FPS 130 may maintain local records of how many connections per day, how many connections per MSISDN, and other such information that may be accessed and retrieved using FPS Admin GUI.

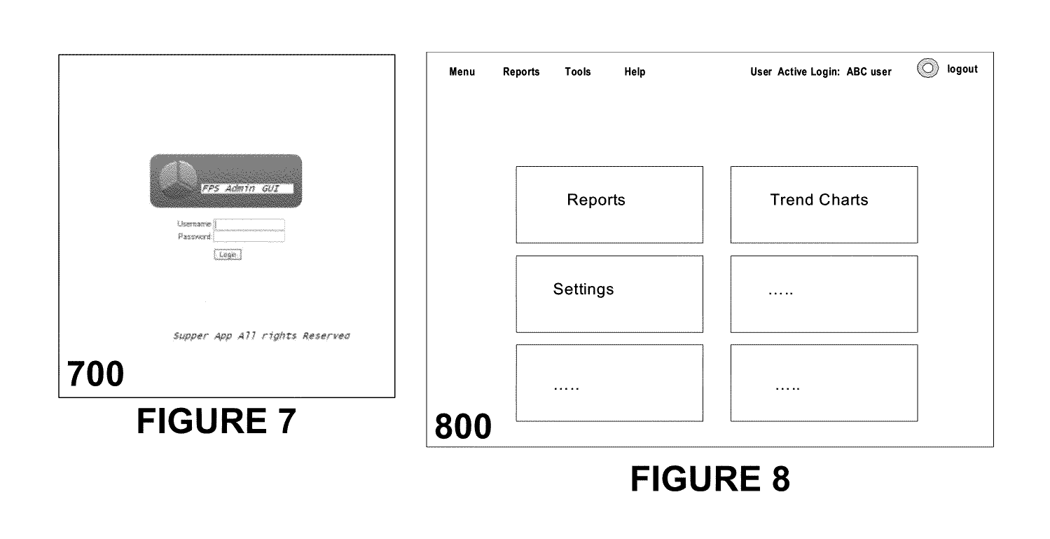

Referring to FIG. 7, an exemplary UCS/FPS 130 graphical user interface 700 may be accessible for sponsors and advertisers of user internet sessions. For example, an administrative graphical user interface may provide access to reports, trend charts, and settings, such as those depicted in user interface 800 in FIG. 8. In a preferred embodiment, each administrative user may obtain information from databases filtered and outputted for data analysis as user preferences. In one aspect, templates may be stored in a way to refresh report when needed. Exemplary trend Charts may include information from database filtered and outputted as charts. Exemplary setting preferences may also be customized and provided via menus to the administrative user.

In another exemplary embodiment of the system and method described, a UCS/FPS 103 may further enlist a user interface that allows for control of user sessions at the service provider level. In this way, an exemplary FPS Server 130 may manage a database, storing sessions info and only authorize user access if certain conditions are met.

In a preferred embodiment, database fields may include the following non-exhaustive list of data entries which may be found in UCS/FPS 130:

| | |
|---|---|
| Main table key | user ID(IMSI + MSISDN) |
| Service provider IP source | User device service provider IP |
| User language | Language of the user |
| Browser type | Browser type |
| OS type | OS type |
| Screen resolution | Screen resolution |

Similar to a UCS/FPS 130 administrative graphical user-interface 700 and settings window 800, an AdS administrative graphical user-interface 500 may be illustrated in an exemplary figure of a system and method described. FIG. 6 provides an illustrative embodiment of an exemplary web AdS administrative graphical user interface 600 for user applications and work in a “n” client-server mode. In an exemplary system and method, web AdS 140 may control and register all Ads demanded from “n” clients applications and send Ads to application client devices 101 from an internal or external advertisement database 145. Exemplary external Advertisement databases may include Grey strips, Mojiva, Google, or Facebook.

For internet service sponsors or advertisers, report and control features may be important. In an exemplary system, the AdS 140 may have a username and password for each advertiser and will record relevant usage info, which may or may not be authorized information from a user, and will manage an internal or external database 145 to control advertisement results. To access all this information/reports AdS 140 will have an administrative graphical user-interface 500/600.

An exemplary web AdS administrative graphical user-interface 600, as shown in FIG. 6, may contain both high level and detailed information. Similar to a UCS/FPS administrative graphical user interface 700/800, web AdS 600 may have links to Reports, Trend Charts, Settings, and advertisement Statistics. In a preferred embodiment, each user may be able to set up the desired screen options display, customizing for its best preference.

Exemplary reports may contain information from advertisement database 145 and may be filtered and outputted for data analysis as a web AdS interface 600 user prefers. In a preferred embodiment, templates may be stored in a way to refresh a database report when needed.

Exemplary trend charts may contain information from advertisement database 145 and may be filtered and outputted as charts. A user may set profile preferences and main screen options and menus like reports, trend charts and any other direct link as may be needed, such as a menu “Daily Report”.

Exemplary advertisement Statistics may include the number of advertisements sent per a period over AdS 140, the number of Ads per specific Advertiser, or the number of Ads per Advertiser to a specific MSIDSN. In an exemplary embodiment, monitoring of Ads transmission to a particular user or specific MSIDSN may allow advertisers to specifically target certain Ads to the user the next time the user logs onto the system. In an additional exemplary embodiment, the user's service experience (bandwidth, speed, breadth of internet experience/search, download capabilities) may be modified or based on the Ads the user receives or the administrative statistics show to be most successful in eliciting sales action from the user.

In an exemplary embodiment, administrative graphical user interface 600 for an AdS 140 may include financial statistics which may allow for control of advertisement amount displayed and/or include the daily or monthly balance due for telecom or service operator(s) and advertiser(s).

In a preferred embodiment, AdS database fields may include the following non-exhaustive list of data entries:

| | |
|---|---|
| Main table key | user ID(IMSI + MSISDN) + |
| | Serial number |
| advertisement | A number or advertisement |
| identification | description |
| Advertiser ID | A number or Advertiser |
| | description |
| Service provider source | Identification of service |
| | provider network source |
| User language | Language of the user |
| Ad result | If Ad was “clicked” by user: |
| | 2, only watched: 1 |

An exemplary administrative graphical user interface 600 may serve as a relevant source of user knowledge and interest and helps web AdS 140 to request the most suitable or cost-effective advertisement based on available/authorized user or user device 101 information.

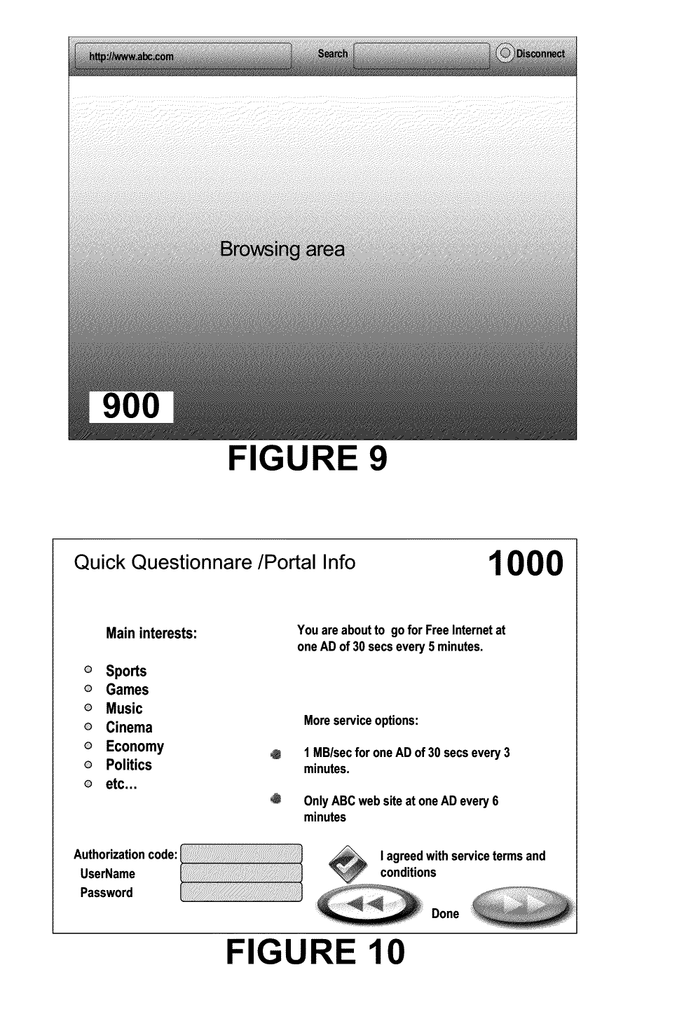

With reference to FIG. 9, once a user device 101 is connected to the system 100, it may see a browsing screen 900. Browsing screen 900 may open as a result of an application on user device 101 configured to operate in accordance with the present system and method. In this embodiment, the application can behave as a browser opening its own program window with a web page search option. Additionally, the exemplary application can be a video and audio player with capabilities, such as streaming any data from internet. Depending on the service provider used to connect to the internet, the exemplary application may restrict web browsing use to only browse certain site(s). In a preferred embodiment in which an application is used with the system and method described, the user may be restricted to only the application browsing window such as the type illustratively embodied in FIG. 9. Alternatively, the exemplary method and system described may just as easily function via a standard web browser 950 (not shown), such as those found through Internet Explorer and Firefox.

In an exemplary embodiment, when the application determines after some time (for example, some number of seconds/minutes) that it is time for an advertisement from AdS 140 to be communicated to user device 101, it will display an advertisement according to advertisement instructions stored on AdS database 145 or entered through user interface 800, such as, for example, advertisement displays over a user's full browsing area, display of advertisements as a vertical bar, banner or video, a sound, etc. In an exemplary embodiment, the interval between advertisement displays may depend on the service provider, its connection type, for example speed, brief questionnaire/portal information provided by user.

FIG. 10 illustrates an exemplary user questionnaire/portal information data collection screen 1000. In information collection screen 1000, a user's preferences may be entered, stored and later-used by the system and method to more efficiently target the service to provide a user, the advertisements to be sent to the user, and other information to control or modify a user's experience with using the system and method. For example, a user may be allowed to access a higher-level connection available only to a few users but with a special internet service provision such as connection speed or data transfer capabilities. According to one aspect of the exemplary system and method, UCS/FPS 130 may control whether a user may access the service desired based on the user's information obtained via information collection screen 1000. Alternatively, an advertiser or service provider sponsor may vet a user based on information collected through the system and method.

For example, a user may wish to establish a VIP connection to take advantage of the best service through a certain provider. In one scenario, the user may not be a desired user for the particular service because the user device 101 may be incompatible with the type of data connection necessary to provide the VIP connection. Alternatively, the user's information does not make the user a prime candidate for advertisements for any of the advertisers or sponsors of the VIP connection, and so the user may be denied access. According to this and other examples, UCS/FPS 130 or AdS 140 may independently or collectively manage user access to internet 125.

According to an exemplary system and method described, the administrative graphical user interface 600 may vary for the same user, or may not present itself if the interface has been accessed many times. In an exemplary embodiment, user interface 600 may be a sponsored portal. In a preferred embodiment where user interface 600 is a sponsored portal, the portal will ask user name, ask to select one or more topics of interest, offer differentiated speed/data access, and, in exchange for faster connections, deliver more Ads to the user device 101.

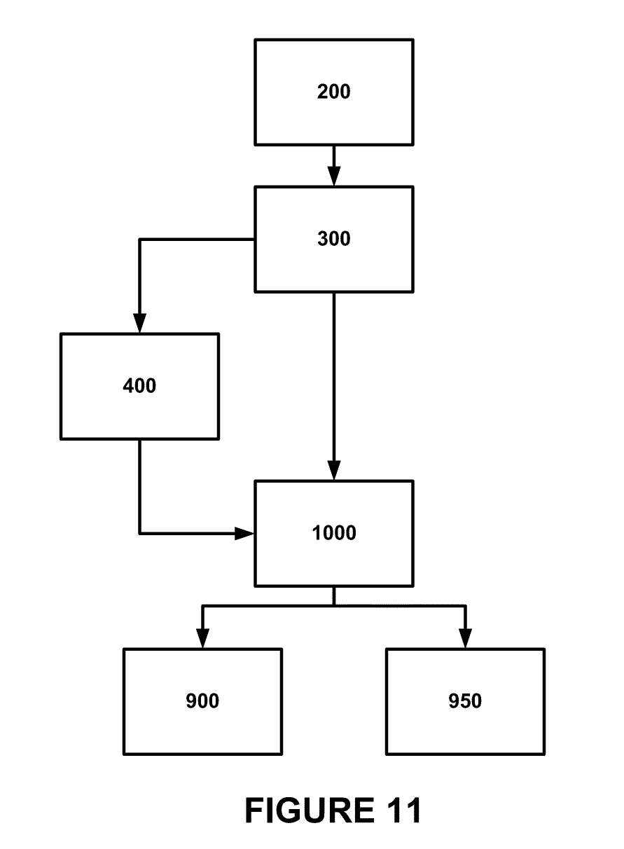

FIG. 11 illustrates an exemplary method of screen display on a user device 101 when operating according to the method described. As illustrated, main screen 200 may be the first screen a user sees when attempting to access the exemplary system described. A user may proceed to service selection screen 300 to select the type of service desired. At that point, new users may be directed to a registration screen 400 which will ultimately allow the user to access an information collection screen 1000. In an exemplary registration step, a service provider may opt to offer user registration via SMS, in which the user may send an SMS to a specific code and then receive a SMS response with an authorization code. Based on the service selected and the information provided, a user may obtain access to an internet service based on their agreement to accept advertisements throughout the internet connection via browsing screen 900 or the user's own standard browser 950.

During the process between information collection screen 1000 and service provision to a user device 101, the request PDP may be established, and the application will send a “hello” message to the UCS/FPS Server 130 (if the server is requested from service provider) and/or AdS 140 so all systems may be updated and ready to deliver/receive advertisements.

Where the connection sought from the user is an LTE/4G connection, instead of PDP context, a connection under an LTE/4G scenario may involve the system managing the so called default EPS Bearer and eventually dedicated EPS Bearer (if a specific QoS information must be sent).

Where the connection selected by the user (for example in FIG. 300) is WiFi, the WiFi network will be scanned for availability of connection, a portal may be authenticated, such as, for example, in authentication procedures with Cisco ISG or CSG/SSG, with data like IMSI/MSISDN as username/password and any other data combination. In a preferred embodiment, the system may require an authorization code be entered, such as, for example, a code previously agreed with the WiFi service provider. After a successful WiFi authentication, the user device 101 will be given an IP address and allow navigation of the internet.

In an exemplary embodiment, the service provider WiFi portal authentication may be done using parameters previously requested to the user during registration, such as at screen 400. When a WiFi connection is available, an exemplary application operating in accordance with the system and method described will send a “hello” message to UCS/FPS Server 130 (if the server is requested from service provider) and AdS 140/145 so all systems are up to date and ready to deliver/receive advertisements.

Upon disconnection from the internet service, a user under mobile IP channel mode may remove the active PDP context/EPS Bearer so that subsequent connections via the service will require recreating a PDP context or EPS Bearer. More specifically, after disconnecting from a service session, the PDP or EPS will be deleted so the quota=zero is no longer present. According to this disconnection embodiment, parameters like “Quota” are no longer present and the service provider may charge the user under its data plan or may refuse a data connection if the user has no data plan. In embodiments where the user disconnects under WiFi mode, the exemplary method and system will disconnect the user device 101 from the WiFi network. In a preferred embodiment, a disconnection action may send a “goodbye” message to UCS/FPS Server 130 (if the server is requested from service provider) and AdS 140 so all systems are up to date.

In the described system and method, reference is made to user devices 101 that may or may not operate with local software to manage the system and method. In an exemplary option, a customized application may be provided to allow a user to have a service selection menu, registration portal and questionnaire portal focused on the internet provider sponsor. In a preferred embodiment, a web channel TV perhaps may simulate the perception of a TV channel and may allow one or more users to watch content only from a particular sponsor of the service. In a preferred embodiment with reference to FIG. 11, in order for an application to be launched, a user must select the service desired, for example on service selection screen 300. Following registration and information collection, a user may be able to browse using a standard browser, but, if such an option is not permitted, may receive the required application to maintain the connection to the service, screens 900 or 950 as illustrated in FIG. 11. As previously discussed, prior to a browsing session, an exemplary system and method may display one or more advertisements on the user device 101.

When an advertisement is to be displayed in the near future to the user, a request arrives at the UCS/FPS Server 130 and AdS 140, such as, for example, when the amount of time before delivery of an advertisement to user device 101 has almost elapsed. An exemplary advertisement request may contain one or more of the following information to the extent available or provided by the user or stored in the system 100: user identification, which may include IMSI, MSISDN, or both; user preferences from an exemplary information collection screen 1000, localization information if available and authorized by user; OS language; Browser type; device 101 brand and version; screen resolution; type of connection; a serial number (generated by an exemplary application); and device IP address. According to one aspect of an exemplary system and method, UCS/FPS 130 may gather and generate as much of the information from the user and/or user device 101 to populate parameters for AdS database 145.

Based on the received info the server will either search in its database for an appropriate advertisement or send this information via API to an external AdS database 145 for a “new” advertisement. This “new” advertisement may be delivered to the application, and, at the designated time, may interrupt the user data connection and display the advertisement. An advertisement may have special instructions for display on the user device 101 such as, for example, “full screen advertisement”, “upper bar advertisement,” “play video or sound.”

As previously-disclosed, servers, such as UCS (130), Ad Server (140), and service portal, may be collected as one physical server, including being located in the cloud or on virtual servers. According to the above, this consolidation of servers may reduce the need for any server within service provider network and may provide straight connection between a mobile application (“APP”) and the servers.

In another exemplary embodiment, each of the servers in FIG. 1 may interface with one another via an API, which may update their contents based on programs designed to reflect user's participation in the networks, e.g., number of uses of system could translate into “loyalty” or “reward” points much like miles accumulation for credit card use. In another aspect, the each of the servers in FIG. 1 may interface with the APP.

An exemplary mobile App API may be programmed with the following exemplary functions in the following exemplary coding format:

1. public boolean startServiceZeroFy (Context context)
start ZeroFy Service.
return true for ok false not ok
2. public boolean stopServiceZeroFy( )
Close ZeroFy service.
return true for ok false for not ok
3. public boolean startConnectionZeroFy( )
Start VPN connection and proceed with ZeroFy Server login into.
To check VPN status it must use getZeroFyVPNStatus function.
To verify successful login function getConnectionStatus must be used.
If all above succeed a App ID must be obtained using function getDeviceID.
@return boolean true for success; false, not.
4. public String getDeviceID( )
Get terminal ID after login with ZeroFy Server.
@return String ID terminal
5. public void stopConnectionZeroFy( )
End VPN connection with ZeroFy server.
6. public int getZeroFyVPNStatus( )
Retrieve VPN status with ZeroFy Server.
@return int
1: vpn not running (default)
2: vpn create socket
3: vpn create files
4: vpn run binary
5: vpn wait socket
6: vpn connecting
7: vpn wait
8: vpn auth
9: vpn get config
10: vpn assign ip
11: vpn add routes
12: vpn connected (VPN ESTABLISHED)
13: vpn reconnecting
14: vpn exiting
7. public void requestWebConnection(String action, String adMetaString)
Request Web/Internet to connection ZeroFy server.
@param action: user action on Ads
@param adMetaString: data received form Ad server
8. public int getConnectionStatus( )
Return connection status.
@return int
1: no access
2: connected
3: “X” seconds, for example 30 seconds left
4: connection expired
5: zerofy offline
6: connection lost
9. public long getBytesUsage( )
Return amount of used bytes.
@return long −1 if no internet connection and >=0 amount of Bytes.
10. public long getQuota( )
Return amount of bytes left.
@return long −1 if no internet connection and >=0 available quota
11. public int getTimeUsed( )
Return consumed time.
@return long −1 if no internet connection and >=0 time consumed
12. public int getTimeLimit( )
Return time left
@return long 1 if no internet connection and >=0 time left

In an exemplary first mode of operation, the system 100 utilizes the APP, such as downloadable software or other program stored on computer readable media, to take advantage of user preferences by storing those preferences on a server. Each APP downloaded by the user may have a serial number. In one embodiment, when installed in a mobile terminal together with terminal serial number and any other terminal info, the APP provides the system with the ability to identify a unique user. Where the APP permits access to multiple terminals/servers, the system 100 can retrieve the user's information, e.g., user email. In one aspect of this embodiment, the system's ability to identify a unique user may provide the advantage of controlling the use of service benefits to the user either from the system 100 or from the sponsor, e.g., discounts, special services/products, rebates. Accordingly, by fixing the identity of a user, the system may substantially eliminate the risk of multiple users taking advantage of the system/sponsor benefits provided more than one time and/or potentially more than one APP.

Additionally, the APP may be able to interface with other APPs via API to allow for inclusion in other existing platforms to obtain benefits from those platform as well, e.g., Facebook posts, eBay, Amazon, etc. Moreover, with respect to the unique user ID embodiments above, sponsor and system benefits, e.g., coupons, may be loaded in the Ad server so when a user in the APP tries to claim the coupon, the coupon's ID may be cross-checked from within a database in the system, such as, for example, a database on the Ad server, to determine whether it had yet been validated, has expired, etc.

In one embodiment of the exemplary mode, the Ad Server receives the user's preferences after ad usage to allow for more precise targeting of advertisements. In this way, the user's preferences for services/products, length of advertisements, or type of advertisement (video, text, or combination), may be stored and used for the next advertisement delivered to the user. Alternatively, the APP may acquire the location of the user via queries from the advertisement, a GPS/Service location using the mobile device as a proxy, or a combination of these. Like in the aforementioned embodiment of the exemplary mode, the location information may be stored on the AdS 140/145 for future reference for the particular user. According to this exemplary mode, communications of user preferences and a server within the system 100 architecture may be secure to prevent unwanted access. Such a secure connection may be through encryption, such as VPN, or other such secured connections known to those skilled in the art.

Further to the exemplary first mode above, the system 100 may maintain the advertisements and transmitted ads on the user device to avoid re-transmission. In another embodiment, the advertisements may have unique identifications (“AD ID”) that may be stored on the user device or on the Ad server so that when the app on the user device searches for the particular advertisement, the AD ID may be used to signal to which advertisement from storage may be necessary for the user to be connected to the internet. In one aspect of this exemplary first mode of operation, the use of AD IDs may avoid needing to retransmit the advertisement to the user's device 101.

In accordance with the aforementioned first mode of operation, the exemplary system 101 may employ a retention algorithm stored on the server housing the advertisements, e.g., the Ad Server or other server, or as part of the device app, which primarily achieves control and retention of advertisements for a particular user. In other words, if an advertisement or type of advertisement does not meet certain metrics, the retention algorithm may delete the advertisement to generate extra storage space. In one aspect of this exemplary operation, the metric may be interactivity of the user with the advertisement, e.g., number of clicks, result-oriented, e.g., how much merchandise has user bought as a result of the advertisement, and/or time of last view, e.g., length of time advertisement has not been displayed.

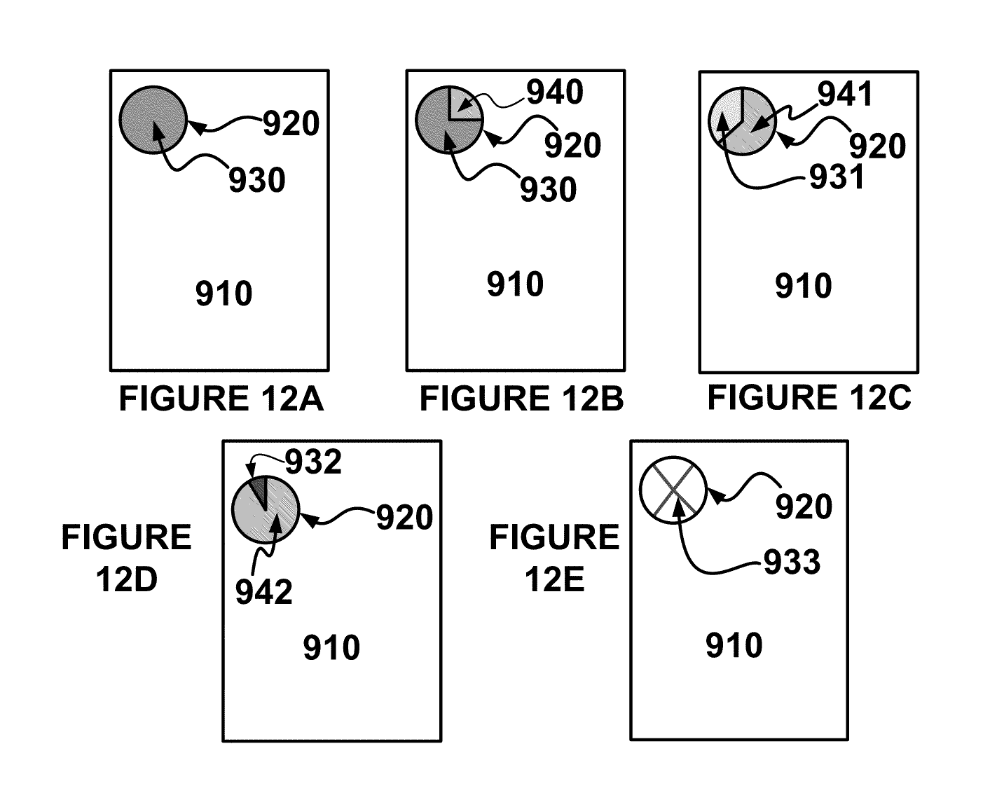

In another aspect of the first mode of operation, the application has a timer control to indicate the remaining connection between the user's device and the internet. Alternatively, the portal may work cooperatively with the application or the AdS 140/145 to provide the timer control. In any of the aforementioned embodiments, the timer control may take the form of a graphic on the user device 101 display, e.g., such as the exemplary displays of FIGS. 12A-E. In one aspect, the graphic may be a shape having gradations that are one color until a first time period elapses, a second color until a second time period elapses, a third color until a third time period elapses, and an “X” or black-out when the internet connection ceases. Alternatively, the timer controller may be part of UCS/FPS 130, AdS 140/145, or any other component in the architecture or software utilized in operation of system 100.

In a preferred embodiment, the timer control provides the user with a graphical representation of the internet connection remaining in terms of time. According to this embodiment, the graphic may be a circle with a green interior to indicate the very beginning of the connection. An illustrative embodiment of this example may be seen in FIG. 12A which may show a browser screen 910 having a circle graphic 920 with an internal color 930. Once the user begins to use the internet connection, the radius of the circle 920 at the 12:00 position will appear as a grey line and with each interval of time, an adjacent grey line is displayed creating a grey area 940 within the graphic 920. In an exemplary embodiment, the original green interior 930 of the graphic 920 gradually becomes grey 941 from a 12:00 position to a second position, such as about the 7:00 position, as may be illustrated in FIG. 12 C. At the second portion, the timer control 920 changes the remaining green interior 930 of the graphic 920 to another color 931, such as yellow, while allowing the grey radii to continue to propagate from the second portion to a third portion, such as about the 10:00 position 942, as may be illustrated in FIG. 12D. At the third portion, the timer control 920 changes the remaining yellow interior 931 of the graphic 920 to another color 932, such as red, while allowing the grey radii to continue to propagate from the third portion to the 12:00 position, rendering the entire circle interior grey. In an exemplary embodiment, the circle graphic may show an “X,” for example, as shown in FIG. 12E, or a blackened interior when the connection to the user has terminated. Any other shape, polygon, polyhedron, or symbol may be used for the aforementioned graphic and any other series of color, shading, or other indicia to indicate differences in the respective portions of the graphic may be employed as well. Additionally, the timer control may send an indication in the form of a SMS or a text message to the user device if it is a mobile device such as a smart phone.

In an alternative preferred embodiment, the timer control may indicate the amount of data a user has left to use for a particular internet service. Any of the aforementioned graphic interfaces and operations may be similarly used for this particular functionality to provide the extent of the user's connection on the user device browser.

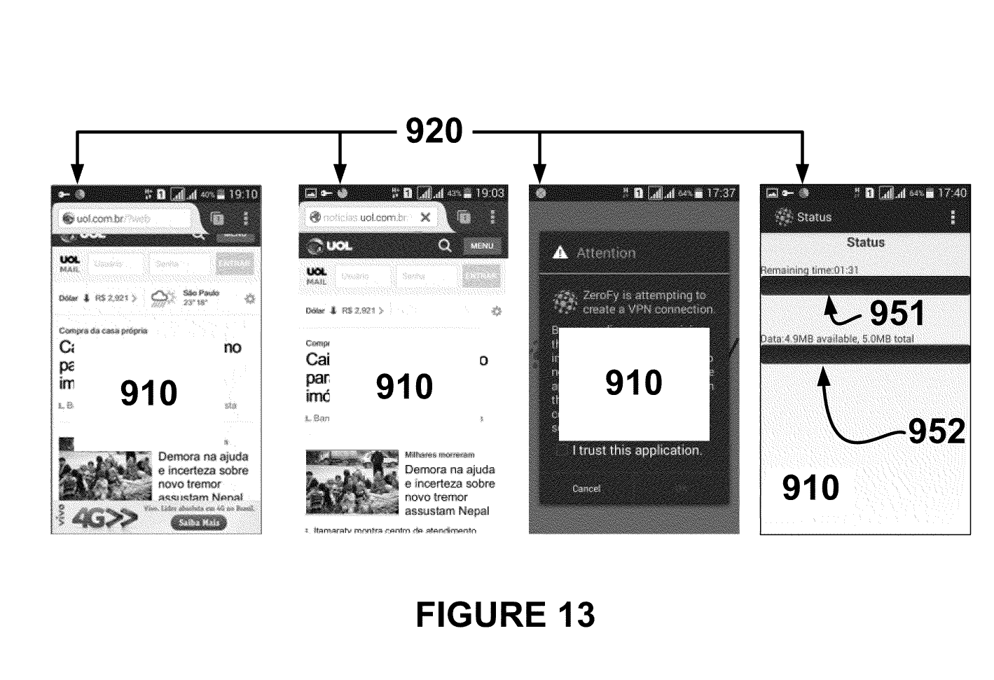

In a yet alternative preferred embodiment, the timer control may keep the user apprised of both data and time remaining on the service request. For example, a user may be allotted ten minutes of internet usage or 5 megabytes of data, whichever expires first. Thus, the graphic indicator of the timer control may show the user an indication of the remainder of the user's service, whether it is time left on the connection or the remaining data. Using the prior circle indicator graphics previously mentioned, a user who downloads video in the first minute of a ten minute 5 MB session may show a very quick change in the circle from the first portion to the second portion with a corresponding change in the remainder of the circle interior from green to yellow due to a 3 MB video download. However, if the video is 4 minutes long, the change in the circle interior from the color yellow to red may be not as fast since the data usage will not change during the 4 minute video. According to this particular embodiment, the user may only see the timer control as a circle with color changes as the session is used, with no indication of what is being used, e.g., data or time. It may be contemplated by those skilled in the art, that two indicators may be used, one for connection time and one for data. Other timing control metrics may be used as well to control the longevity of the user's session, e.g., the amount of time spent on prior advertisement. Thus, the user device 101 may display the amount of time and data used by the user during the session and provide an indication of how much of either remains for the particular connection to the internet. An exemplary illustrative embodiment of these displays may be found in FIG. 13. For example, the display may show timer controller indicators 920 or status indicators for time 951 or data 952, for example, to indicate characteristics of the user's connection via the system 101.

In an exemplary embodiment, the user session data based on amount of time and/or usage of the system 101 may be used to provide benefits to the user due to repeated use of the system. For example, a user who has accessed the system “n” times may be categorized as a first level user and be allowed access to different benefits and/or SUCs. According to this example, a user who has accessed the system “n+1” times may be categorized as a second level user with different benefits and/or SUCs that may not be available to a first level user.

According to another aspect of the exemplary embodiments involving SUCs, an exemplary user in the system 101 may have access to a storage or account of the SUCs provided to them via the system. The storage or account may reside on one or more of the servers of the system previously described, or may stay on the user's device 101. In one other aspect, an exemplary SUC stored in an account of one user may be transferred to the account of another user of the system. In an exemplary embodiment, a user with children or extended family may accumulate SUCs and translate some or all of them to their children or other members of the family. In another exemplary embodiment, a company that accumulates SUCs may transfer these to the employees.

In another embodiment, the timer controller may be used by an AdS advertisement to show the remaining time/data to be used by the advertisement. Alternatively, the timer controller of the AdS advertisement may also indicate how many users are engaging the advertisement at any given moment.

In a further embodiment, the timer control may also be used to show the remaining time/data usage for a particular advertisement selected by the user. The previously-disclosed graphical timer controls may be used for the advertisements as well. In embodiments where a mosaic of advertisements may be provided on the user's display, the duration/data usage for each advertisement in the mosaic of choices may also be displayed as well, including the duration/data used on particular advertisements from any prior sessions. In embodiments where a mosaic style display of advertisements may be employed, a user may be able to see 3 or 5 different banners and be prompted to choose one in order to begin the session. As a result of that selection, the system 100 may record these choices of the user as user session data.

In another exemplary embodiment of the first mode of operation, an APP may request user registration. The registration may be a process that can vary from time to time, based on the type of information requested, for example, sponsor-specific information, product-specific information. Accordingly, such an app may be a hard-coded registration process or request to the server portal for internal storage thereafter. Alternatively, the app may store different registration with its own identification (REG ID), to avoid retransmission.

In an exemplary second mode of operation, the APP may be designed to provide focused advertisements, e.g., from one source or sponsor, from one type of product, within a certain AD ID range or ranges. In an exemplary embodiment, the focused advertisements may be hard coded within the code of the APP to reduce need for re-transmission from an Ad Server. Alternatively, the APP would have one or more AD IDs that delineate the focused advertisements from the other advertisements on an AdS 140/145. In another exemplary embodiment, the APP may have a dynamic list of focused advertisements based on a URL/IP address of the user. In yet another exemplary embodiment, the servers may resort to a list of AD IDs that correspond to the focused advertising of the APP.

According to the exemplary second mode of operation, the sponsor of an advertisement may create the focused advertisement list, e.g., the AD IDs, dynamic list of URL/IP, via an administrative interface (ADI). An exemplary ADI may permit the sponsor to (i) generate use incentives, e.g., coupons, discounts, rebates, offers, (ii) update use incentives and advertisements, (iii) acquire statistics on the focused advertising, including viewer meta data and other metrics for use in understanding interaction with potential customers and marketing media, and/or (iv) change advertisements in the focused advertisement pool, e.g., delete, modify. The permissions of the ADI may be accessible via remote means by the sponsor or may be part of the software code for the APP that may be updated in the future by later upgrades from the sponsor that interact with the APP.

In another exemplary embodiment, one or more specific event APPs may possess rules such as, validation period and specific perimeter use (via GPS or Terminal Service location or both). In this example one or more features may be hard-coded within the APP. Alternatively, the equivalent of an AdS 140/145 or Fraud Prevention utility 130 may contain the rules. In a further exemplary embodiment, specific-event APPs may also have specific IDs so any kind of APP can be distinguished at server level and specific access rules applied. As the white label, “event APPs” may also have a dynamic URL/IP rules via admin interface.

In an exemplary third mode of operation, a user, such as a business, may load a version of the mobile APP API (such as the exemplary APP API with code provided above) for the aforementioned system 100 into a part of their own APP, e.g., internet service for Ad display logic, timer functionalities for internet connection/ad display. Alternatively, the user may select advertisements to display form an Ad server in which they may be stored. Further alternatively, the APP may be linked to a local drive containing such advertisements selected for use by the user. According to the exemplary third mode of operation, the APP API becomes an add-on or compliment to pre-existing applications.

In an exemplary fourth mode of operation, the system 100 architecture may be relegated to an intranet structure that bases the service connection on advertisement display as well as device address among a group of constituents, e.g., M.A.C. address, URL/IP of devices/servers. Accordingly, a finite number of constituents may be able to access the internet following advertisement, message board or questionnaire displays on their devices in order to perform group tasks, e.g., on-site work operations, in-person marketing or any other types of engagement.

In any of the above embodiments, user session data such as (but not limited): source terminal IP from user APP, destination internet/URL IP, start session time, end session time, amount of data usage, etc., may be collected and retrieved by sponsors and/or sent to the sponsor on demand. The aforementioned user session data may be stored on one or more servers within the system 100 architecture, e.g., the UCS 130 and/or AdS 140/145, and may be accessed with the use of a PIN or password held by the sponsor. Alternatively, the APP may keep the user session data as a cookie or other file on the user device 101.

According to other exemplary embodiments previously described, the Ad server may provide a web tool so publishers can load their advertisements and associate with such advertisements a weight based on importance, number of displays allowed, amount of time and volume for example. Additionally, as described with the user session data embodiments above, the number of displays allowed to users may also dictate the weight of the advertisement. In this example, the weight accorded an advertisement due to user session data may allow a publisher/sponsor to gauge interest in the product/service, amount of money to dedicate to the product/service/advertising, and other information to determine the viability and success of the advertisement. In an alternative embodiment, the user session data and advertisement information previously disclosed may be subject matter that is available to the user on their device 101.

An additional benefit of the system 100 previously described and the various modes of operation is that the servers may exercise control over the user session, e.g., restricting internet access to a specific list or URL or IP based on specific rules and/or Ads/Sponsors/Event/Questionnaire etc. Accordingly, the system 100 may be used for oversight of the users of the system and/or adhere to a particular compliance policy or legal request, e.g., subpoenas, warrants, requests for judicial assistance for international discovery matters.

In a further exemplary embodiment of the system 100 disclosed herein, a user may be prompted to use SUCs to avoid advertisements being shown during a session. In this exemplary embodiment, the user may select stored SUCs on the system or the user's device 101 to “lock” the AdS 140/145 from delivering an advertisement during an internet session initiated by the user. The “lock” would set a timer control in much the same way as previously described, to show how long the “lock” is active so as to prevent the next advertisement from being sent. According to this exemplary embodiment, the user's selection of the “lock” feature of the system 101 may be made at the prompt screen or through some other selectable feature on the APP display.

In another exemplary embodiment, the user may pay for an SUC to avoid advertisements or obtain higher user status in the system 101. According to the latter aspect of this embodiment, the user status may be based on frequency of use, amount of data used, or amount of time spent, for example, on the system 101. Additionally, the system may randomly select users to be recipients of SUCs that may be put to use in accordance with any of the proposed embodiments herein.

In yet another exemplary embodiment of the system disclosed herein, a user may seek additional sponsors and/or advertisers to be an advertiser or sponsor of the system and/or AdS 140/145 advertisements. In this way, the user may either use the session to directly communicate with the additional sponsor and/or advertiser or be permitted to use a feature of the system that when engaged alerts the system that the particular additional sponsor or advertiser is desired as an additional sponsor or advertiser by the user, e.g., a “like” button linking the website of the additional sponsor and/or advertiser, a text box in which the user enters the additional sponsor and/or advertiser, a “snip” button that captures the image of the additional sponsor and/or advertiser for use by the system 100. Alternatively, the APP may display all contact email addresses associated with the website being visited by the user during a session, e.g., using web-crawler or other site-search technologies known to those skilled in the art. According to this alternative embodiment, if the user wishes to select the entity as a potential additional sponsor and/or advertiser, the user may engage a prompt to add the entity, which the system, via the APP, may translate into a request to be emailed to the entity using the information obtained from the entity website during the user's visit. In this exemplary embodiment, the system and APP may keep count of the number of users seeking to add particular entities as potential sponsors and/or advertisers and use the information to garner additional sponsorship and/or advertisement support for the system 100. Alternatively, the request email sent by the APP may also provide the entity with up-to-date information on the number of users who have asked the entity to sponsor the system and/or be an advertiser for AdS 140/145 advertisements. Alternatively, the request may also provide the amount of time users spend viewing the entity's advertisements, and other useful metrics that a non-affiliated entity may be given in order to gauge interest in the entity and potential benefits of being a sponsor or advertiser.

While the system and method have been described by way of example embodiments, it is understood that the words which have been used herein are words of description, rather than words of limitation. Changes may be made, within the purview of the appended claims without departing from the scope and spirit of the system and method in their broader aspects. Although the system and method have been described herein with reference to particular interrelated structures, interrelated materials, and interrelated embodiments, it is understood that the system and method is not limited to the particulars disclosed.

I claim:

1. A method for providing ad-based internet service, comprising the steps of:
connecting a user device to the internet as a result of an advertisement displayed on the user device;
displaying at least one advertisement on the user device following a selection made on the user device related to the at least one advertisement;
displaying a digital indicator on the user device indicating the extent of the user's connection to the internet based on the at least one advertisement displayed; and
changing the digital indicator displayed on the user device during the period of the user's connection to the internet to reflect the user's connection thereto.

2. The method of claim 1, wherein the at least one advertisement is a mosaic of advertisements.

3. The method of claim 1, wherein the digital indicator comprises a shape that changes color depending on the user's connection.

4. The method of claim 3, wherein the color reflects a period of time.

5. The method of claim 3, wherein the color reflects data usage.

6. The method of claim 1, wherein the step of connecting the user device to the internet uses an application stored on a processor.

7. The method of claim 1, wherein the at least one advertisement is stored on at least one server.

8. The method of claim 1, wherein the at least one advertisement is stored on the user device.

9. The method of claim 1, further comprising the step of receiving session information from the user's connection to the internet.

10. The method of claim 9, wherein the information is stored on a server.

11. The method of claim 9, wherein the information is received from the user's device.

12. The method of claim 1, further comprising a request of internet data to a session control server.

13. An internet connection controller, comprising:
a timer controller that displays an indicator on a user device after at least one advertisement is displayed on the user device, the indicator comprising a digital representation of a user's internet connection, the representation representing an amount of time remaining on the user's internet connection or an amount of data used by the user during the internet connection, the digital representation being based on at least one advertisement displayed on the user device.

14. The internet connection controller of claim 13, further comprising a means for storing the at least one advertisement on the user device.

15. The internet connection controller of claim 13, further comprising a means for displaying the at least one advertisement on the user device.

16. The internet connection controller of claim 13, wherein the timer controller is part of an application stored on a processor.

17. The internet connection controller of claim 16, wherein the processor is part of a user control server.

18. The internet connection controller of claim 16, wherein the processor is part of the user device.

19. The internet connection controller of claim 13, further comprising a digital representation of the display of at least one advertisement on the user device, the representation representing an amount of time remaining on the at least one advertisement's display or an amount of data used by the user device to display the at least one advertisement.

20. The internet connection controller of claim 13, further comprising a means for storing data associated with the user's internet connection.
